(19) United States
(12) Patent Application Publication
(10) Pub. No.: US 2012/0061518 A1
(43) Pub. Date: Mar. 15, 2012

(54) APPARATUS AND METHOD FOR QUICKLY RELEASING A DOME IN A DOMED SATELLITE ANTENNA

(75) Inventor: Marty R. Taeger, Burlington, IA (US)

(73) Assignee: WINEGARD COMPANY, Burlington, IA (US)

(21) Appl. No.: 13/227,876

(22) Filed: Sep. 8, 2011

Related U.S. Application Data
(60) Provisional application No. 61/381,705, filed on Sep. 10, 2010.

(51) Int. Cl. B64G 1/64; B23P 17/00; B64G 1/52

(52) U.S. Cl. 244/131; 29/402.08

(57) ABSTRACT

An apparatus and method for quickly releasing, without using any tools, the dome from the base of a domed satellite antenna system. An actuator moves in each of a number of quick-release fasteners around the dome to an unlocked position. The dome is lifted to reveal the operational components, the revealed components can then be changed (e.g., by setting switches to receive different satellites), and then the dome is replaced over the base. Each actuator is moved to the locked position to re-attach the dome to the base.

### RELATED APPLICATION

The present application is based on and claims priority to the Applicant's U.S. Provisional Patent Application 61/381,705, entitled “Apparatus And Method For Quickly Releasing A Dome In A Domed Satellite Antenna,” filed on Sep. 10, 2010.

### BACKGROUND OF THE INVENTION

1. Field of the Invention

The present invention relates to a satellite antenna system having a dome and, more particularly, the invention relates to an apparatus and method for removing a dome in a domed satellite antenna system.

2. Discussion of the Background

Domed satellite antenna systems are used worldwide to receive various types of programming in a variety of environments. Such domed satellite systems are sealed to prevent adverse environmental conditions (for example, moisture) from affecting the operational components found under the dome and above the base structure. Domes are attached to the base with a number of fasteners such as screws that require tools for removal.

In many domed satellite antenna applications, a separate indoor unit (IDU) is used to allow the user to communicate (wired or wireless) with the operational components under the dome such as, for example, changing individual satellites or satellite combinations. A need exists to provide easy and quick access by the user to switches and other components inside the dome so as to eliminate the additional costs associated with the external IDU. A need therefore exists to allow the user to easily and quickly remove the dome and to change the operational settings for a new satellite or satellite combinations.

In many applications throughout the world, some satellites require the use of a linear LNB (low noise block) in the operational components under the dome. When using a linear LNB, it may have to be skewed or rotated in various positions for different physical receiving locations to work properly. Again, a costly internal motor with external control is often provided to a user for making these position changes. A need exists to allow the user to quickly and easily remove the dome and to adjust the linear LNB manually for that physical region of use to save the costs of the internal motor and external control.

A further need exists to provide a removable dome from the base that can be quickly removed by a user and re-installed in a sealed abutment with the base to environmentally protect the internal components.

A final need exists to provide quick-release fasteners on the domed satellite antenna system that do not require the use of tools by the user and that remain on the dome and/or on the base so that none of the quick-release fastener is misplaced or lost when the dome is removed.

### SUMMARY OF THE INVENTION

An apparatus and method is set forth for easily and quickly releasing, without using any tools, the dome from the base of a domed satellite antenna system. The satellite antenna system has operational components under the dome that are mounted to the base. The user uses his/her fingers to move an actuator in each of a predetermined number of quick-release fasteners from a locked position to an unlock position. The quick-release fasteners can be connected at equally-spaced locations around the dome or around the base. The dome is lifted, in response to moving the actuators of all of the quick-release fasteners to the unlocked position, from the base to reveal the operational components. The user then changes at least one of the revealed operational components such as setting switches to receive different satellites or changing the skew of a linear LNB. The user then places the dome back over the base and moves, with his/her fingers, each actuator in the quick-release fasteners from the unlocked position to the locked position to re-attach the dome to the base.

The summary set forth above does not limit the teachings of the invention especially as to variations in the apparatus and method as more fully set out in the following description taken in connection with the accompanying drawings.

### BRIEF DESCRIPTION OF THE DRAWINGS

The present invention can be more readily understood in conjunction with the accompanying drawings, in which:

FIG. 1a is a perspective view illustrating a domed satellite antenna system using the quick-release fasteners of the invention to attach the dome to the base.

FIG. 1b is a top planar view of the domed satellite antenna system of FIG. 1a showing the locations of the quick-release fasteners of the invention on the dome.

FIG. 2 (prior art) is an exploded planar view of a first quick-release fastener.

FIG. 3 (prior art) is a side planar view of the quick-release fastener of FIG. 2 fastening a conventional removable panel to a conventional frame.

FIG. 4 is a side cut-away planar view taken along section lines 4-4 of FIG. 1b showing the quick-release fastener of FIG. 2.

FIG. 5 is a side cut-away planar view of FIG. 4 with the dome removed.

FIG. 6 (prior art) is a partial perspective view of a second quick-release fastener using a pivoting lock wire as an actuator.

FIG. 7a is a cutaway view of a third quick-release fastener using a quarter turn wing head stud as an actuator.

FIG. 7b is a bottom planar view of FIG. 7a.

FIG. 8 is a flowchart illustrating a first method of the invention.

FIG. 9 is a flowchart illustrating a second method of the invention.

FIG. 10 (prior art) is a perspective view of some of the operational components found in a conventional domed satellite antenna system.

### DETAILED DESCRIPTION OF THE INVENTION

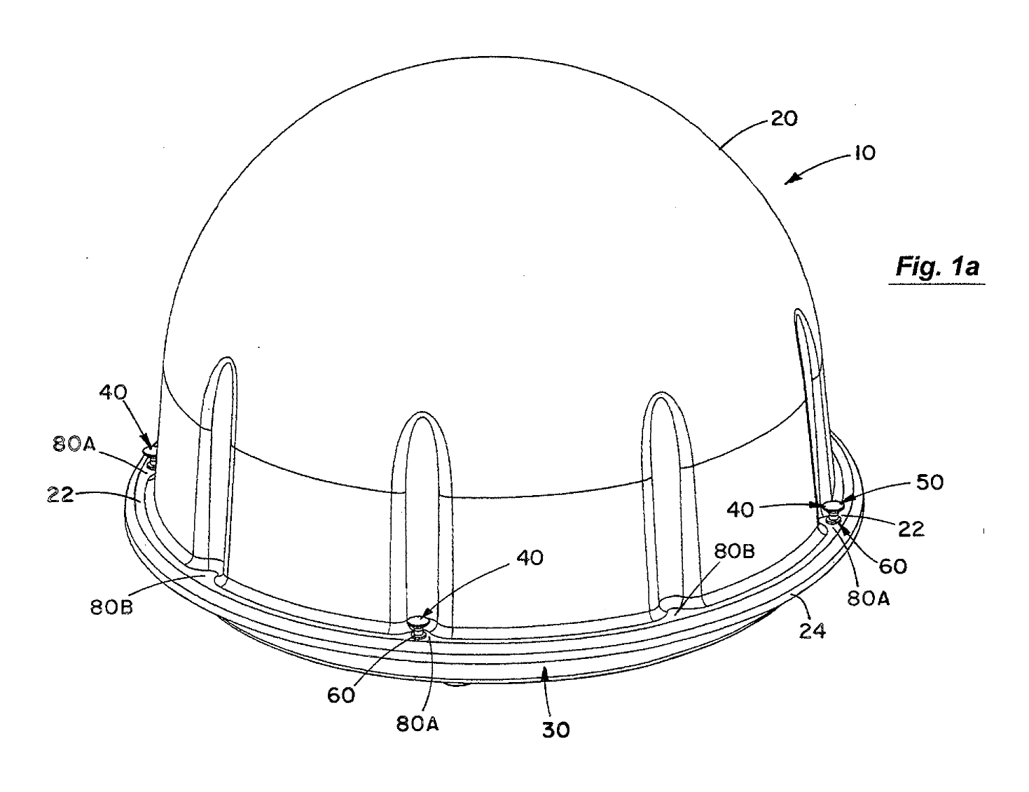

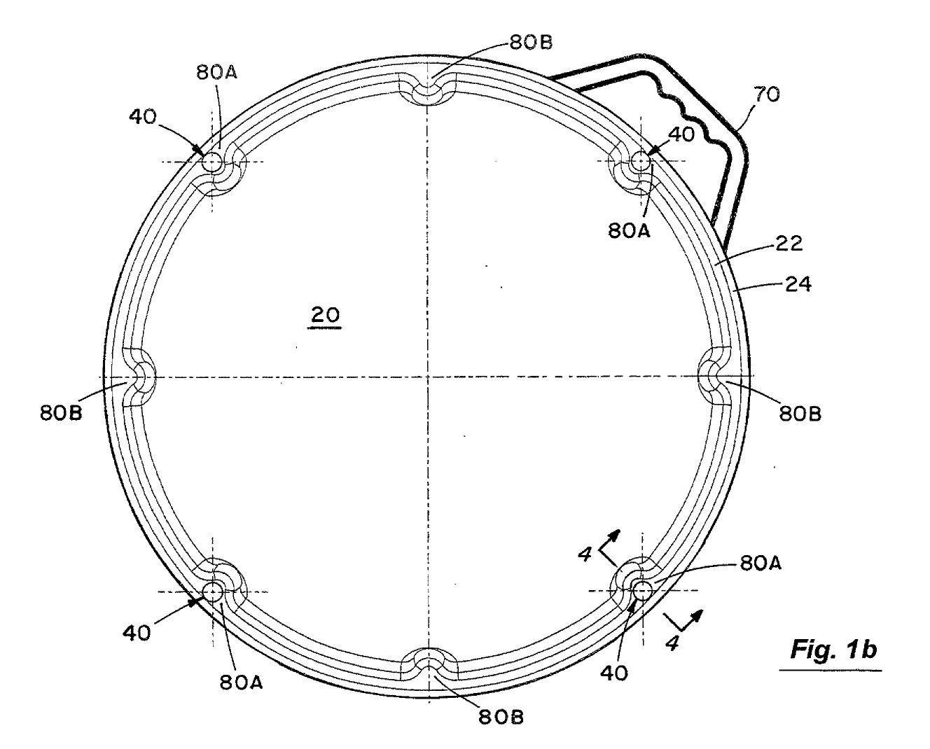

In FIG. 1a, a domed satellite antenna system 10 is shown having a dome 20 and a base 30. The domed satellite antenna system 10 is of conventional design and a wide variety of different shaped domed satellite antenna systems 10 are conventionally available that can use the apparatuses and methods of the invention.

In FIG. 1a, a predetermined number of quick-release fasteners 40 of the invention are shown in a locked position attaching the dome 20 to the base 30. Each quick-release fastener 40 has a plunger 50 for releasably engaging a grommet 60 in formed holes around the dome 20 and base 30. The domed satellite antenna system 10 shown in FIG. 1a uses four quick-release fasteners 40 spaced at 90 degrees around the circumference of the dome 20. Any suitable number of quick-release fasteners 40 could be used (e.g., eight). Preferably, the quick release fasteners 40 are equally spaced around the circumference of the dome 20. FIG. 1b shows the four equally-spaced quick-release fasteners 40 located around the dome 20. The domed satellite antenna system 10 shown is conventionally available from Winegard Company, 3000 Kirkwood Street, Burlington, Iowa 52601 as the CARRYOUT antenna and conventionally has eight screw fasteners at locations 80A and 80B. A tool is required to remove these conventional screw fasteners. The system 10 has been modified under the invention herein to use only four quick-release fasteners 40 at locations 80A thereby eliminating all screw fasteners at locations 80A and 80B. The system 10 shown in FIGS. 1a and 1b is portable and has a handle 70.

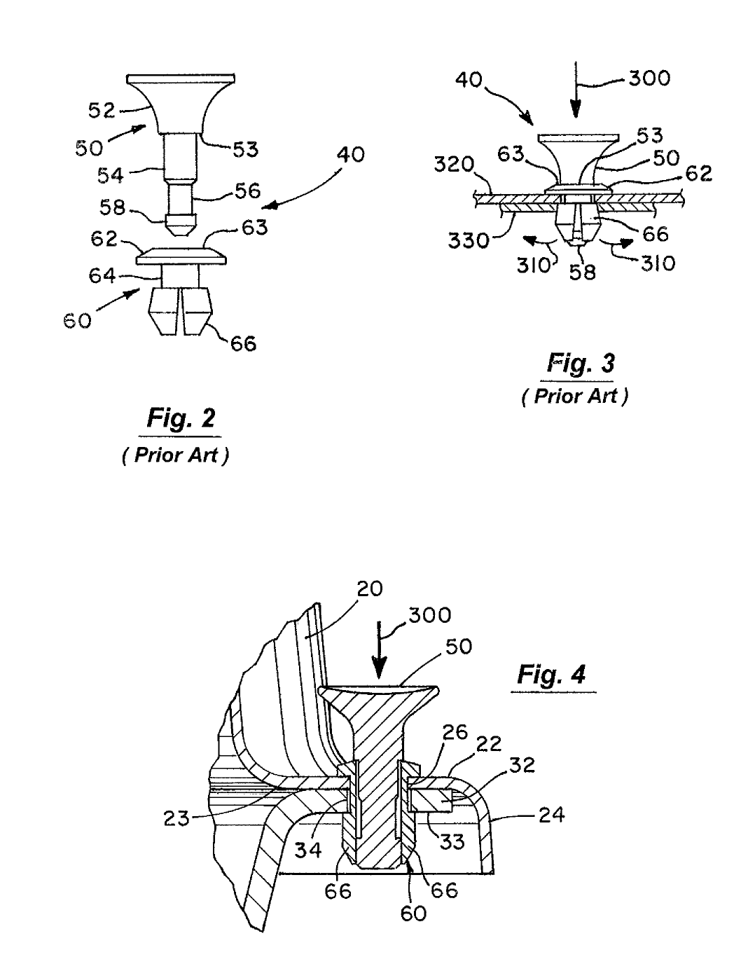

The quick-release fastener 40 of FIG. 1a and 1b is shown in greater detail in FIGS. 2 (prior art) and 3 (prior art) and is conventionally available and commercially known as the NYLATCH push/pull style panel fasteners such as those, for example, available in the 5/16 inch size, G Range: 0.118-0.207 from Southco, P.O. Box 0116, 210 North Brinton Lake Road, Concordville, Pa. 19331.

In FIG. 2 (prior art), the grommet 60 of the quick-release fastener 40 has an upper cap portion 62 followed by a mid-cylindrical portion 64 and terminates in a lower expandable portion 66. The plunger 50 of the quick-release faster 40 has an upper easy grip portion 52 followed by a first cylindrical portion 54 and then by a second cylindrical portion 56 and terminates in an enlarged bottom cap 58.

As shown in FIG. 3 (prior art), when the plunger 50 is moved in direction 300 (to a lock position), the bottom 53 of the upper easy grip portion 52 abuts the top 63 of the upper cap portion 62 causing the lower expandable portion 66 of the grommet 60 to move outwardly in the direction of arrows 310 so that removable panel 320 is fastened to frame 330. FIGS. 2 and 3 show the prior-art use of the NYLATCH quick-release fastener 40 for removing a panel 320 from a frame 330.

The quick-release fastener 40 is used in the present invention to fasten the dome 20 to the base 30 as shown in FIG. 4. The dome 20 has a circular flat flange 22 with a formed dome hole 26 and a downwardly extending circular rim portion 24 (also shown in FIG. 1a). The base 30 has a corresponding circular, flat flange 32 with a formed base hole 34 and that abuts against the undersurface 23 of the flange 22 of the dome 20 and is seated against the rim 24. With the plunger 50 pushed into the grommet 60, as shown by arrow 300, the expandable portion 66 has moved outwardly to fasten the flange 32 to the flange 22 as shown in FIG. 4. The grommet expandable portion 66 is flared out capturing the underneath side 33 of the base flange 32, thereby fastening the base 30 to the dome 20. The lip 24 extending downwardly towards the base 30 aids in creating an environmental seal along with the abutment of flanges 22 and 32 to prevent water and dust, for example, from entering into the inside of the dome 20. In some satellite antenna systems, the dome 20 and the base 30 are not circular and have a different geometric shape with flanges 22 and 32 having the same geometric shape.

In FIG. 5, the dome 20 is shown removed from the base 30. When the plunger 50 is moved in the direction of arrow 500 (to an unlocked position), the expandable portion 66 moves in the direction 510 to release from abutting against the base flange 32 and to move out of the formed base hole 34. The expandable portion 66 of the grommet 60 is not flared and will fit through the formed hole 34 on the flange 32 of the base 30. With the dome 20 removed, the quick-release fastener 40 remains in (i.e., captured) the formed flange hole 26 of the flange 22.

The quick-release fastener 40 can be any suitable fastener that provides a quick release without the use of tools and is captured on the domed satellite system 10 for prompt use by a user. As shown in FIG. 5, the quick-release fastener 40 is captured entirely on the dome flange 22, but in another embodiment, as discussed next, the quick-release fastener can be captured partially on the dome 20 and partially on the base 30.

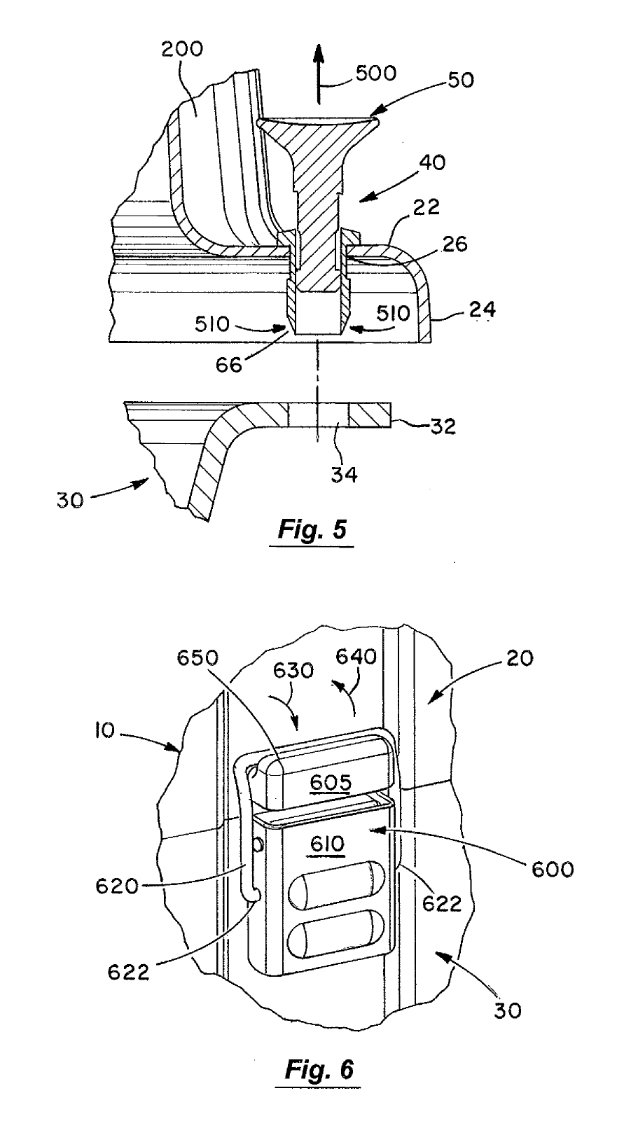

In FIG. 6, a quick-release fastener (prior art) 600 is shown fastening the dome 20 to the base 30 of a domed satellite antenna system 10. The fastener 600 has a first portion 605 affixed to the edge of the dome 20 and a second portion 610 affixed to the edge of the base 30. A lock wire or rod 620 pivots 622 in the second portion 610 to unlock (in the direction of arrow 630) or to lock (in the direction of arrow 640) the dome 20 to the base 30. Locking occurs by moving the lock wire 620 over the formed ridge 650 on the first portion 605 to engage the area behind the ridge 650. Movement of the lock wire 620 can be manually done with the user's fingers. In the embodiment of FIG. 6, the quick-release fastener 60 is captured on the system 10 with the first dome portion 605 affixed to the dome 20 and the second base portion 610 with the pivoting lock wire 620 affixed to the base 30. An example of such a fastener is found on the Winegard carrying case for the Carryout GM-MPI Manual Portable satellite dish system.

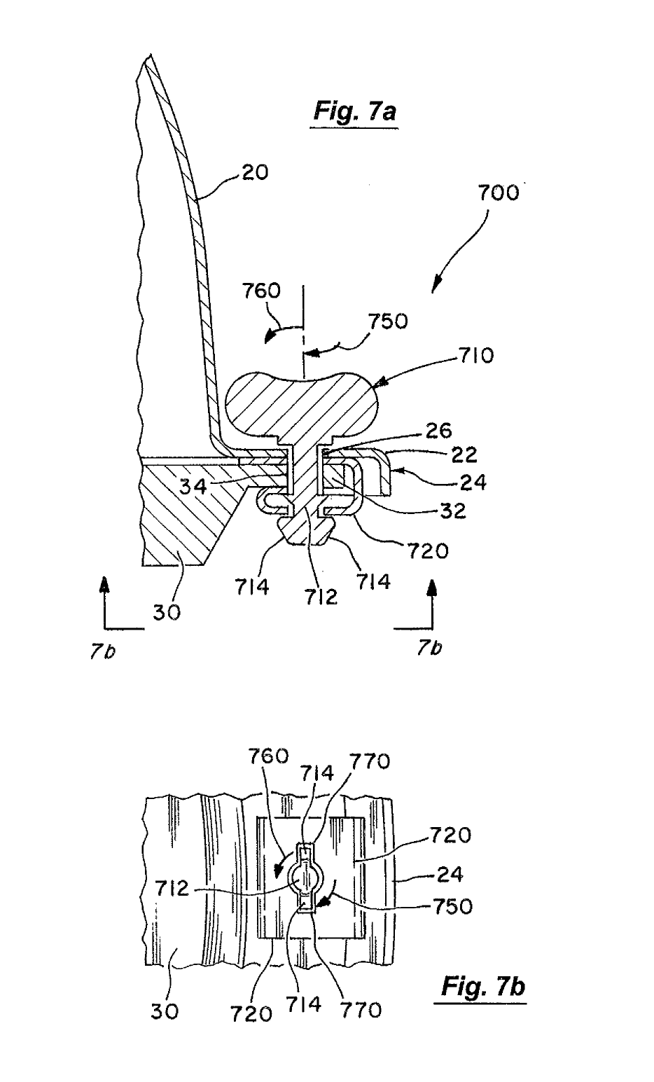

In FIGS. 7a and 7b, a quick-release fastener (prior art) 700 is shown which has an upper wing head portion 710 pivotally connected in the formed dome hole 26 of the dome flange 22 and a lower retainer clip portion 720 connected over the formed base hole 34 of the base flange 32. The wing head portion 710 has a downwardly extending stud 712 with opposing flares or protrusions 714. The wing head 710 is turned, as shown by arrow 750, a quarter turn (90 degrees) from the view shown in FIG. 7a to unlock the stud 712 from the clip 720 so that the dome 20 can be released from the base 30 by lifting the stud 720 up and out of the clip 720 and hole 34. In this embodiment, the base flange 32 captures the clip portion 720 of the quick release fastener and the dome flange 22 captures the wing head portion 710. As shown in FIG. 7b, the flares 714, when turned 750 to unlock, access a keyway 770 in the clip 720 for easy removal. To lock the dome 20 to the base 30, the stud 712 is inserted into the clip 720 and turned 90 degrees in the direction of arrow 760. One commercial source for this fastener is McMaster-Carr Supply Company, P.O. Box 740100, 6100 Fulton Industrial Boulevard SW, Atlanta, Ga. 30336 as part no. 93442A534-A561. The invention is not limited to the three different fasteners shown and discussed above.

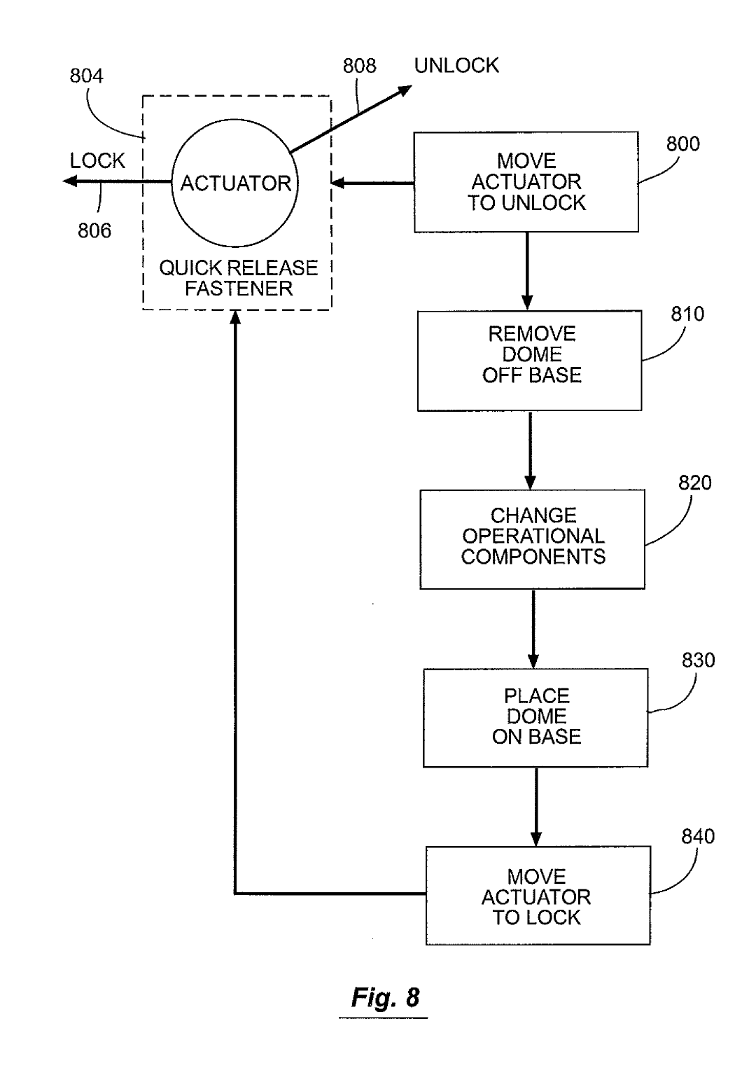

In FIG. 8, a first method of the invention is shown with respect to the quick-release fastener 40 of FIGS. 1 through 5, the quick-release fastener 600 of FIG. 6, and the quick-release fastener 700 of FIG. 7. In step 800, without any tools, a user uses fingers to move an actuator 802 in each of the quick-release fasteners 804 from a locked position 806 to an unlocked position 808. With reference to FIGS. 1a and 1b, the user pulls with his/her fingers each plunger 50 (the actuator) in the direction of arrow 500 to an unlocked position (FIG. 5), to release the dome 20 from the base 30. With reference to FIG. 6, the user lifts the lock wire (the actuator) 620 with his/her fingers in the direction of arrow 630 to an unlocked position. And, with reference to FIG. 7, the user turns the wing head (the actuator) 710 with his/her fingers in the direction of arrow 750 to an unlocked position. In step 810 and in response to moving the actuator of each quick-release fastener 804 to an unlocked position 808, the user lifts and removes the dome 20 from the base 30 to reveal the operational components of the satellite antenna system 10.

This provides access by the user to the operational components of the satellite antenna system 10 under the dome 20 so that the user can change at least one of the components (such as to adjust, to remove or add components) in step 820 as discussed with respect to FIG. 10. After the changes to the operational components have been made, the user replaces the dome 20 over the base 30 to align holes 26 and 34 (FIG. 5) in step 830. The user in step 840 uses his/her fingers to move the actuator 802 in each of the quick-release fasteners 804 to the locked position 806 to firmly attach the dome 20 to the base 30. In FIGS. 1 through 5, the user pushes each plunger (the actuator) 50 downwardly in the direction of arrow 300 (FIG. 4) to engage the plunger 50 into the grommet 60 to attach the dome 20 to the base 30. In FIG. 6, the user moves the lock wire (the actuator) 620 in the direction of arrow 640 to lock the wire 620 over the ridge 650. In FIG. 7, the user turns the wing head stud (the actuator) 710 in the direction of arrow 760 a quarter turn to lock the stud 710 to the retainer clip 720.

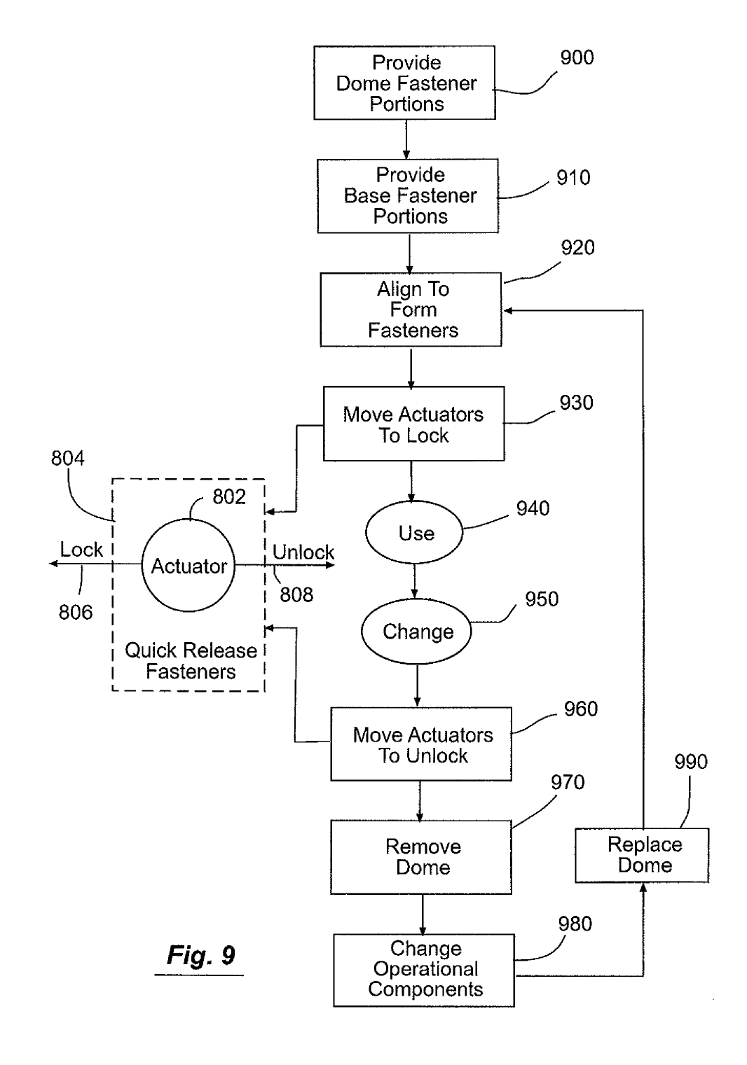

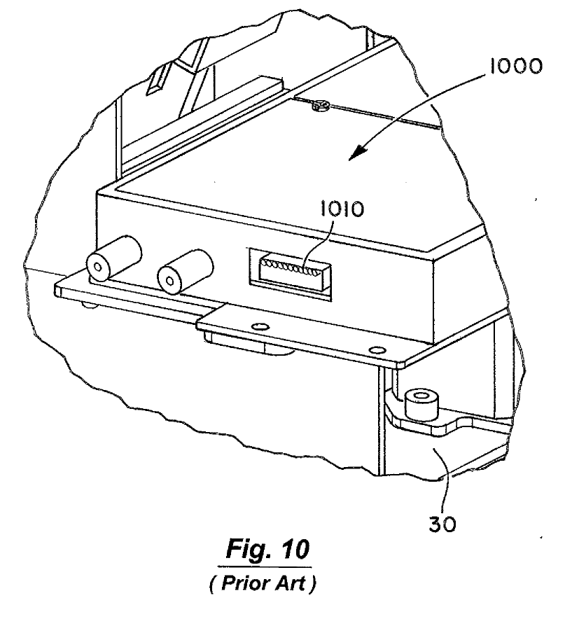

Another embodiment of the method of the invention is shown in FIG. 9. In stage 900, a predetermined number of equally-spaced, quick-release dome fastener portions are provided on a circular flange 22 formed at the bottom of the dome 20. In FIGS. 1-5, the dome fastener portion is the plunger 50 and grommet 60 in hole 26. In FIG. 6, the dome fastener portion is the first portion 605. In FIG. 7a, the dome fastener portion is wing head stud 710 in hole 26. In stage 910, a corresponding predetermined number of equally-spaced quick-release base fastener portions are provided on a circular flange 32 formed at the top of the base 30. In FIGS. 1-5, the base fastener portion is the formed base hole 34. In FIG. 6, the dome fastener portion is the second portion 610. In FIG. 7a, the base fastener portion is the retainer clip 720 and hole 34. In stage 920, a predetermined number of quick-release fasteners are formed when the quick-release dome fastener portions align with a corresponding predetermined number of equally-spaced quick-release base fastener portions. This is fully shown on FIGS. 1-5, FIG. 6 and FIGS. 7a and 7b above. In stage 930, the user without the use of tools and with fingers only, moves an actuator 802 in each of the quick-release fasteners 804 to a locked position 806 fastening the dome 20 to the base 30.

The antenna system 10 is used by the user in stage 940. Should the user need to change 950 the operational components inside the antenna system 10, then in stage 960, the user moves the actuator 802 to the unlocked position 808 and removes 970 the dome 20 from the base 30 to reveal the operational components. In stage 980, the user changes at least one of the revealed operational components, as discussed next with respect to FIG. 10. In stage 990, the user replaces the dome 20 over the base 30. Stage 920 is re-entered. Finally, in stage 930 the user moves, with the fingers only and without the use of tools, each actuator 802 in the quick-release fasteners from the unlocked position 808 to the locked position 806.

An illustration of changing operational components 1000 (step 820 of FIG. 8) mounted to the base 30 is shown in FIG. 10 (prior art). Here, a set of DIP (dual-in-line package) switches 1010 are shown for access by the user to set for the desired satellites for the user to use the system 10 to receive signals from. By way of example, the user can conventionally set the DIP switches 1010 for DISH satellites or for DIRECTV satellites. As another example (not shown), linear LNBs are used in Europe which require skew adjustment as the system 10 is moved to different locations.

The above disclosure sets forth a basic embodiment of the invention described in detail with respect to the accompanying drawings with a number of variations discussed. Those skilled in this art will appreciate that various changes, modifications, use of other materials, other structural-arrangements, and other embodiments could be practiced under the teachings of the invention without departing from the scope of this invention as set forth in, but not limited to, the following.

I claim:

1. A method for quick releasing a dome from a base of a domed satellite antenna system to change at least one operational component mounted to the base under the dome, said method comprising:
moving, without using tools, an actuator in each of a plurality of quick-release fasteners from a locked position to an unlocked position, the plurality of quick-release fasteners connected around the circumference of the dome;
lifting the dome, in response to moving the actuator to the unlocked position, from the base to reveal the at least one operational component;
changing the revealed component;
placing the dome over the base after changing the revealed component; and
moving, without using tools, each actuator in the plurality of quick-release fasteners from the unlocked position to the locked position, in response to placing the dome, to attach the dome to the base.

2. The method of claim 1 wherein the quick-release fasteners are retained on the domed satellite antenna in the unlocked position.

3. The method of claim 1 wherein the quick-release fasteners comprise a quick-release dome fastener portions spaced around a circular flange formed at the bottom of the dome, and corresponding quick-release base fastener portions spaced around a circular flange formed at the top of the base for removably engaging the quick-release dome fastener portions.

4. A method for quick releasing, by a user, a dome from a base of a domed satellite antenna system to change at least one operational component mounted to the base under the dome, said method comprising:
providing a predetermined number of quick-release dome fastener portions spaced around a circular flange formed at the bottom of the dome;
providing a corresponding predetermined number of quick-release base fastener portions spaced around a circular flange formed at the top of the base;
forming a predetermined number of quick-release fasteners when the quick-release dome fastener portions lock with the corresponding quick-release base fastener portions to fasten the dome to the base;
moving, with the fingers of the user and without the use of tools, an actuator in each of the quick-release fasteners from a locked position fastening the dome to the base to an unlocked position releasing the dome from the base;
lifting the dome, in response to moving the actuator to the unlocked position, from the base to reveal at least one operational component;
changing the revealed operational component;
aligning the dome over the base after changing the revealed component, with the quick-release dome portions on the circular flange of the dome aligned with the quick-release base portions on the circular flange of the base; and
moving, with the fingers of the user and without the use of tools, each said actuator of the quick-release fasteners from the unlocked position to the locked position to re-attach the dome to the base.

5. A quick-release apparatus for a domed satellite antenna, said domed satellite antenna having a dome with a lower edge, a base with an upper edge, and operational component's mounted to said base and under said dome when said dome lower edge connects to said base upper edge, said quick-release apparatus comprising:
a plurality of quick-release fasteners mounted on said domed satellite antenna; and
an actuator in each of said plurality of quick-release fasteners connecting the dome to the base when each actuator moves, without using any tools, into a locked position; said dome releasing from the base when each actuator moves, without using any said tools, into a release position;
wherein the quick-release fasteners are retained on the domed satellite antenna when the dome releases from the base.

6. The quick-release apparatus of claim 5 wherein the quick-release fasteners are retained on the dome when the dome releases from the base.

7. The quick-release apparatus of claim 5 wherein the quick-release fasteners have a dome portion that is retained on the dome and a base portion that is retained on the base when the dome releases from the base.

8. The quick-release apparatus of claim 5 wherein the dome lower edge is a dome flange, wherein the base upper edge is a base flange and wherein the quick-release fasteners are equally spaced on the dome flange and on the base flange.

9. The quick-release apparatus of claim 8 wherein the dome flange and base flange are circular.

10. The quick-release apparatus of claim 5 wherein at least one of the quick-release fasteners comprises a plunger extending through the dome lower edge to releasably engage a grommet in the base upper edge.

11. The quick-release apparatus of claim 5 wherein at least one of the quick-release fasteners comprises a pivoting wire lock.

12. The quick-release apparatus of claim 5 wherein at least one of the quick-release fasteners comprises a push/pull style panel fastener.

13. The quick-release apparatus of claim 5 wherein at least one of the quick-release fasteners comprises a stud with flares engaging a keyway in the base upper edge, said stud being rotatable between a locked position and an unlocked position.
